(19) United States
(12) Patent Application Publication
(10) Pub. No.: US 2002/0138660 A1
(43) Pub. Date: Sep. 26, 2002

(54) Method and system for the redirection of client requests

(76) Inventors: Bernd Eilers, Hamburg (DE); Thorsten O. Laux, Hamburg (DE)

Correspondence Address: SONNENSCHEIN NATH & ROSENTHAL, 1301 K STREET NW, SUITE 600, EAST TOWER, WASHINGTON, DC, 20005, US

(21) Appl. No.: 10/103,772

(22) Filed: Mar. 25, 2002

(30) Foreign Application Priority Data
Mar. 23, 2001 (EP) 01 106 462.3-1244

(51) Int. Cl. G06F 9/46; G06F 15/16

(52) U.S. Cl. 709/313; 709/203

(57) ABSTRACT

A method and system for redirecting client requests includes a request handling program at the server. A client request is transmitted from a client via the request handling program to a primary application program. The primary application program generates a redirection instruction based on the client request and returns the redirection instruction to the request handling program. The request handling program, upon receiving the redirection instruction, forwards the client request to a secondary application program selected for serving the request. A response from the secondary application program is returned to the client via the request handling program. A communication session between the client and the primary application program may involve the use of internal resource locators and, for redirecting a client request, internal resource locators may be converted into external resource locators allowing the second application program to access a requested resource.

This application claims priority from European Patent Application No. 01 106 462.3-1244, filed Mar. 23, 2001, the contents of which are herein incorporated by reference.

### BACKGROUND OF THE INVENTION

1. Field of the Invention

The present invention relates to redirecting client requests in a client and server system.

2. Description of the Related Art

Today's communication networks allow a user at any location to quickly access virtually any kind of information or service throughout the world, including, for example, viewing and retrieving information, buying a product, or accessing a user account, for example, for setting personal data or the like.

Generally, to access a service, a user operating a client connects to a network and selects a service or a server for providing the service. The client may connect to the server via any kind of communication link, including computer networks such as local area networks (LANs), wide area networks (WANs), or dedicated communication links, including wireless links.

After establishing a connection, a user operating the client may then control the execution of an application at the server in order to obtain the desired service. Parts of the application to provide the requested service may reside at the client, and other parts of the application may be located at the server. The above applications may, for example, include office applications, such as managing documents and data files, and may include visualizing information, banking services, shopping services and the like.

As it is desired that clients, such as home computers, laptop computers, and mobile devices, including mobile phones, personal data organizers or the like, be reduced in size and weight, a recent trend in the art is to move more and more parts of an application as outlined above, from the client to the server. Most importantly, computationally intensive parts of an application may be moved from the client to the server, while maintaining control of the execution of the application through the client.

For example, in an office application such as editing a large document, or a session involving a plurality of linked documents, a client may not have sufficient resources for intermediately storing the required large amounts of data and/or to perform the necessary editing operations without introducing an unacceptable latency, i.e., time lag, between entering a command and a corresponding response.

In this situation, it may be preferred to allocate functions such as intermediately storing data and/or performing the required processing commands in editing a document, to the server which has large resources. Only functions for visualizing the processing results may suitably be maintained at the client, such that a user may supervise and control any processing operations. Operations at the server may be controlled through the client by transmitting corresponding control commands, inputted by a user, from the client to the server.

Control commands for controlling an application at the server may be constituted by requests, including information such as a specification of a requested resource, and a task type, for example, for specifying whether data is to be retrieved or to be received, and optionally data content.

The request may be used to instruct the server to perform certain operations such as processing data, editing data, retrieving data, storing data, and the like. Corresponding processing operations will then be executed at the server, and a processing result, if necessary, will be returned to the client, for example, for local display.

However, with the applications as outlined above becoming more complex, an application may be subdivided into a plurality of application modules or programs, the application modules cooperating in serving user requests. Further, more than one application may be involved in serving a user request.

Therefore, it may occur, that a client request from a client is received at a server at a particular application program of an application which is not, or not alone, responsible for serving the received request. In this case, it may be desirable to redirect the client request to another application program located at the same server or located at another server.

A straightforward approach for redirecting a client request could be to notify the client that the particular application or application program is not responsible for servicing the client request. In this case, the client may itself redirect the request to another suitable application or application module.

However, a communication bandwidth of the communication link between the client and the server may be limited, i.e., due to using a low bandwidth wireless connection, a low bandwidth fixed connection or any other connection having a low bandwidth. In these cases, notifying the client to redirect the client request to another suitable application or application program at the same server or another server may create an unacceptable communication load and latency, in particular if a large number of such redirections occur.

### SUMMARY OF THE INVENTION

Methods and systems consistent with the present invention include redirecting client requests while maintaining a high overall performance in executing an application involving a client, and applications at at least one server. This includes advantageously allowing the redirection of client requests from the client to an application program at a server by utilizing a request handling program, thus avoiding an increase of a communication load between the client and the server due to the redirection of client requests. The client request issued by the client may be received at the first application program through the request handling program, the request handling program forwarding the client request from the client to the first application program. The client request is not redirected through the client to a second application program for serving the client request, as in the prior art, but redirected through the request handling program based on the redirection instruction.

The redirection instruction may include information specifying that the request handling program is selected for redirecting the client request to the second application program.

Thus, the request handling program is placed in the communication path between the client and the server and handles the redirection instruction involving redirecting the client request to the second application program in order to maintain a low communication load between the client and the request handling program at the server, as this connection potentially has a low bandwidth.

Further, since the client does not directly communicate with the primary application program and secondary application program, the inventive arrangement is also suited to facilitate maintaining security.

Thus, as opposed to a conventional arrangement, the client accesses the parts of the primary application program which redirect the client requests, requiring security provisions only at the primary application program, as the request handling program is the only entity which is in direct contact to the client(s), i.e., to the outside world.

One embodiment consistent with the present invention includes a method in a data processing system of redirecting client requests at a server in a client-server system, having the steps of receiving a client request from a client at a first application program; generating a first redirection instruction based on the client request at the first application program; transmitting the first redirection instruction to a request handling program; and instructing the request handling program with the first redirection instruction to transmit the client request to a second application program to serve the client request.

Further, the first application program may determine the second application program for serving the client request, i.e., based on a list of available application programs and may add to the redirection instruction at least address information of the second application program for serving the client request.

The client request may include an internal resource locator previously transmitted from the first application program to the client and specifying a requested resource, the internal resource locator being valid in a communication between the first application program and the client.

By defining internal resource locators, i.e., in a communication session between the client and the server through the request handling program, potentially long external resource locators may be converted into shorter internal resource locators, which allows the further saving of bandwidth on the potentially low bandwidth connection between the client and the request handling program/server.

Generating the first redirection instruction may include obtaining an external resource locator based on the internal resource locator, the external resource locator allowing the second application program to access the resource, and generating the first redirection instruction may encompass including the external resource locator into the first redirection instruction.

As the internal resource locator, used in a communication session between the first application program and the client, is generally not known at the second application program, the internal resource locator is advantageously transformed into an external resource locator, the external resource locator constituting a resource locator understood by the second application program. For example, the external resource locator may be composed according to a communication protocol agreed upon in communications between the client and the application programs.

Generating the first redirection instruction may include a look-up operation in a resource locator table associating internal resource locators and external resource locators at least used by the second application program, the internal resource locator constituting an address for indexing into the resource locator table to identify the second resource locator.

Accordingly, in a communication session between the client and the first application program external, i.e., long—resource locators may be stored in a resource locator table and internal resource locators may be constituted by addresses specifying the corresponding external resource locators. Thus, potentially very short internal resource locators may be used in a communication between the client and the first application program, further saving bandwidth on the potentially low bandwidth connection between the client and the request handling program/server.

The redirection instruction may be used to instruct the request handling program to modify the client request based on information included in the redirection instruction.

Preferably, the internal resource locator included in the original client request may be replaced by the retrieved external resource locator corresponding to the internal resource locator of the client request and/or address information of the second application program may be included into the client request to be transmitted to the second application program.

Thus, a suitably modified client request is redirected to the second application program by the request handling program, the modified client request preferably including an external resource locator corresponding to the original internal resource locator and/or address information of the second application program.

The first redirection instruction may be generated based on a first part of the client request, and a second part of the client request may be served by the first application program. For example, this may include generating a response for transmission from the first application program to the client through the request handling program.

Accordingly, a client request may be partially served at the first application program and be partially served at the second application program. The first redirection instruction may include an external resource locator determined by the first application program, and specifying a resource needed for completing the client request, this resource being provided by the second application program.

Further, a third application program for serving a third part of the client request may be determined at the first application program and a second redirection instruction may be generated based on the third part of the client request. The second redirection instruction may then be transmitted to the request handling program, instructing the request handling program to transmit a modified client request to the third application program.

Thus, a client request may be further split Lip into parts for service at a third application program involving a further redirection of the client request. The original client request may thus be suitably divided into parts for service at the first application program, the second application program and the third application program.

The first and second application program may be executed on a single server.

Alternatively, the first application program may be executed at a first server and the second application program may be executed at a second server, i.e., remote from the first server, and the request handling program may be constituted by a data processing device at least further including functions of a load balancer.

Thus, a redirection of client requests may involve application programs, i.e., part of a single application, executed at one or a plurality of servers. Further, the request handling program may include further functions such as functions of a load balancer balancing requests from a plurality of clients onto a plurality of servers.

According to another embodiment consistent with the present invention, a method in a data processing system of redirecting client requests at a server, includes the steps of receiving at a request handling program, a client request from a client; forwarding the client request to a first application program; receiving at the request handling program, a first redirection instruction from the first application program; and forwarding the client request to a second application program.

Thus, the request handling program may suitably transmit requests in a communication session between a client and a server, including forwarding client requests to application programs and redirecting client requests based on redirection instructions to other application programs.

The method may include forwarding a response to the first redirection request from the second application program to the client.

The first redirection instruction may include address information of the second application program and information specifying that the request handling program is selected for transmitting the first redirection instruction to the second application program.

The client request may include an internal resource locator previously transmitted from the first application program to the client and specifying a requested resource, the internal resource locator being valid in a communication between the first application program and the client.

The first redirection instruction may include an external resource locator associated with the internal resource locator, the external resource locator allowing the second application program to access the resource.

The request handling program may intermediately save and may modify the client request based on information included in the redirection instruction.

The modification of the client request may include at least one of replacing the internal resource locator by the external resource locator; and including the address information of the second application program into the client request.

The first redirection request may be associated with a first part of the client request, and a second part of the client request is served by the first application program by transmitting a response to the client through the request handling program.

The method may further include receiving a third redirection request based on a third part of the client request; and transmitting the third redirection request to a third application program for serving the third redirection request.

Further, the method may include determining a second application program for serving the client request, if the first application program and the second application program do not form part of a same application.

The request handling program may communicate with a server executing the first and second application program.

Further, the request handling program may communicate with a first server executing the first application program and with a second server executing the second application program.

A plurality of request handling programs may be provided, wherein each request handling program further executes the functions of a load balancer.

Further, the client request issued by the client may include a plurality of internal resource locators and/or a plurality of external resource locators.

Thus, a single request may be used for instructing a plurality of operations at a plurality of application programs at one or a plurality of servers. Internal resource locators may be converted into external resource locators, if necessary, external resource locators included in the client request may be directly served. The client request may be suitably redirected to target application programs, as required.

The application programs may be constituted by Java servlets and the second resource locator may include a uniform resource locator, e.g. as used in the HTTP (Hyper Text Transport Protocol).

In another embodiment consistent with the present invention, there is provided a data processing system in a client and server system, for redirecting client requests at a server, the system including a server computer having at least one memory including a plurality of server programs of which a first application program receives a client request from a client; generates a first redirection instruction based on the client request; transmits the first redirection instruction to a request handling program; instructs the request handling program with the first redirection instruction to transmit the client request to a second application program to serve the client request; and at least one processor that runs the server programs.

In another embodiment consistent with the present invention, there is provided a data processing system in a client and server system, for redirecting client requests from the client at the server, the system including a server computer having at least one memory including a plurality of server programs of which a first application program receives a client request from a client; generates a first redirection instruction based on the client request; transmits the first redirection instruction to a request handling program; instructs the request handling program with the first redirection instruction to transmit the client request to a second application program to serve the client request; and transmits a response from the second application program to the client; and at least one processor that runs the server programs; and a client computer having a memory including a client program that provides a client request to the server, and that receives the response sent by the second application program at the server; and a processor that runs the client program; and a network between the server computer and the client computer.

A computer readable medium may be provided, in which a program is embodied, where the program is to make a computer execute one or a plurality of the above operations. A computer program product may include the computer readable medium.

Therefore, in another embodiment consistent with the present invention, there is provided a computer readable medium containing instructions that cause a data processing system in a client and server system, to perform a method of redirecting client requests at a server, the method including the steps of receiving a client request from a client at a first application program; generating a first redirection instruction based on the client request at the first application program; transmitting the first redirection instruction to a request handling program; and instructing the request handling program with the first redirection instruction to transmit the client request to a second application program to serve the client request.

Further, in another embodiment consistent with the present invention, an apparatus, in a client and server system, provides for the redirection of client requests at a server, the apparatus including means for receiving a client request from a client at a first application program; means for generating a first redirection instruction based on the client request at the first application program; means for transmitting the first redirection instruction to a request handling program; means for instructing the request handling program with the first redirection instruction to transmit the client request to a second application program to serve the client request.

There has thus been outlined, rather broadly, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it Is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 depicts a data processing system in a client-server configuration suitable for practicing methods and systems consistent with the present invention;

FIG. 2 depicts a flowchart of the steps performed by the programs depicted in FIG. 1;

FIG. 3 depicts a flowchart of the steps performed by the programs depicted in FIG. 1 according to another embodiment consistent with the present invention;

FIG. 4 depicts a flowchart of the steps performed by the programs depicted in FIG. 1 according to another embodiment consistent with the present invention;

FIG. 5 depicts a flowchart of the steps performed by the programs depicted in FIG. 1 according to another embodiment consistent with the present invention.

FIG. 6 depicts a flowchart of the steps performed by the programs depicted in FIG. 5 according to another embodiment consistent with the present invention;

FIG. 7 depicts a time sequence of steps for redirecting client requests according to another embodiment consistent with the present invention;

FIG. 8 depicts a time sequence of steps for redirecting client requests according to another embodiment consistent with the present invention;

FIG. 9 depicts application programs in a server configuration suitable for practicing methods and system consistent with another embodiment of the present invention; and

FIG. 10 depicts a flowchart of the steps performed by the programs depicted in FIG. 9.

### DETAILED DESCRIPTION OF THE PREFERRED EMBODIMENTS

Method and systems consistent with the present invention include redirecting client requests received from a client to a server, such that the programs at the server redirect the client request and does not redirect the client request back through the client, thus avoiding an increase in communication load between the client and the server.

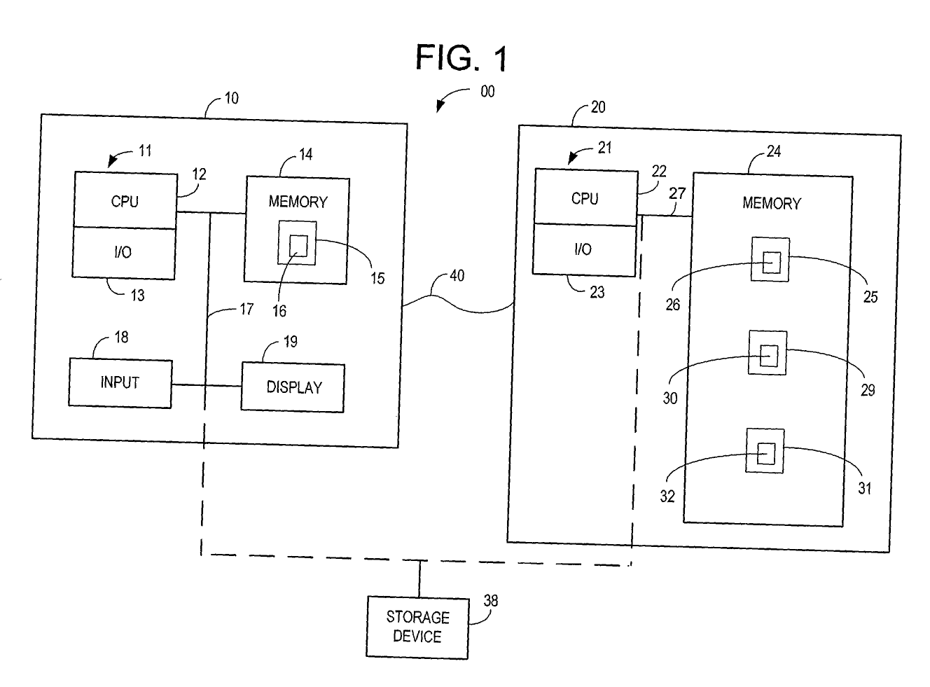

In a first embodiment consistent with the methods and systems of the present invention, FIG. 1 shows a data processing system 00 for redirecting client requests received from a client 10 during an application being executed at a server 20.

In the following, examples of the individual elements shown in FIG. 1 will be outlined in further detail. It is noted that the following examples serve illustration purposes only and do not limit the invention. Modifications of the elements shown in FIG. 1 within the scope of the invention will readily occur to the person skilled in the art.

The client 10 shown in FIG. 1 may be a general purpose data processing device, such as a personal computer, a mobile terminal such as a mobile computing device, a mobile phone or a mobile data organizer operated by a user wishing to access a service remote from the client 10, i.e., at the server 20. The client 10 may include a central data processing unit 11 (or processor 11 as processing means), including a central processing unit 12 and an input/output (I/O) interface 13, or may be connected to a data processing unit external to the client 10. The client 10 may further include a memory 14 or other program storage means for storing a program 15 having a data structure 16, the program 15 to be executed involving the client 13. The storage means 14 may be located within the client 10 or external thereto. Even though only a single client 10 is illustrated in FIG. 1, other embodiments may include a plurality of similar clients 10 connected to the server 20.

The client 10 may also include an input such as a keyboard, as input means 18, and a display 19. The data processing unit 11, memory 14, input 18, and display 19, are connected by internal communication links such as an internal bus 17, or external communication links, or the like.

A program application executed involving the client 10 may for example involve the editing of data files, the rendering of data such as to adapt content for the display of web pages, may correspond to mathematical or logical operations on contents of a data file, may relate to home banking applications, office applications such as spread sheet applications, drawing applications, e-mail applications or similar. An application may also relate to simply visualizing data, such as a text document, an image file, video data or may relate to reproducing audio or audio visual information.

The program 14 is executed at a processing unit 11, or may be realized in hardware providing predefined services. The program 14 preferably provides computationally expensive services in executing one of the above outlined applications, for example rendering operations or the like.

The server 20 may be constituted by a general purpose data processing unit 21, and is preferably a data processing unit with large resources, i.e., high processing capabilities and large memories for storing large amounts of data. The server 20 may be a single unit or may be a distributed system of a plurality of servers 20 or data processing units and may be shared by multiple users operating a plurality of clients 10.

In one embodiment consistent with the present invention, the server data processing unit (i.e., processor) 21 or processing means may be constituted by a central processing unit 22 and an I/O interface 23, but may also be constituted by a distributed central processing unit including a plurality of individual processors on one or a plurality of machines. The server data processor 21 may have access to at least one server memory or memory storage means, or a large number of application programs, for providing various services to users, i.e., for performing various operations on data files as desired by users operating clients such as the client 10. FIG. 1 shows representatively a primary memory 24 having a program 25 with data structure 26, and a secondary memory 28 which stores two programs 29 and 31, having data structures 30 and 32.

The programs 25, 29, 31 can include a separate program code for performing a desired operation or service, or may each be part of a module of a larger program providing the service. The programs 25, 29, 31 may also include a plurality of sub-programs or modules performing sub-operations of a service.

Even though in FIG. 1, only three application programs 25, 29, 31 are illustrated, a plurality of application programs will preferably be present. Further, while FIG. 1 shows programs 29 and 31 residing within one storage device (i.e., memory 28), the programs 29 and 31 may be provided in separate memory storage devices, or all three programs 25, 29, 31 may be provided in a single memory storage device. Further, while programs 29 and 31 are shown in FIG. 1 as being provided on server 20 with memory 24 and program 25, memory 24 and program 25 may be constituted by a separate device, i.e., on a separate server. If so, communications between the application programs 29, 31 and program 25 may be performed through a communications network such as a local area network or a wide area network or may include dedicated communication links and may include wireless communications.

Further, programs 25, 29, and 31 may reside on different servers, each server at least hosting one application.

The data processing unit 21 and the memories 24, 28 may be connected to each other by internal communication links such as an internal bus 27, or external communication links, or the like.

The client 10 and the server 20 may also have access to another storage device 38, which may be internal to the client 10 and server 20, or external thereto.

The client 10 is connected to the server 20 via an external communication link 40, such as a network connection, including a local area, company-wide intranet, or a wide area network such as the Internet, and/or a connection via a dedicated communication line and/or including wireless communications. It is also possible that the communication link 40 includes combinations of the above examples. The communication link between the client 10 and the server 20 may also have low bandwidth.

Generally, since the client 10 is connected to the server 20 via a publicly accessible network or communication link, i.e., the client 10 may be used to dial into a network node and then to connect to the server 20—the communication link between the client 10 and the server 20 may be subject to unauthorized access. As opposed thereto, the programs 25, 28 may preferably be located in memories 24, 28 within a local area network, for example a local area network of a company operating the server 20, and therefore these connections may be secured relatively easy.

Further, although aspects of one implementation of the present invention are depicted as being stored in memory, one skilled in the art will appreciate that all or part of systems and methods consistent with the present invention may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of data processing system have been described, one skilled in the art will appreciate that a data processing system suitable for use with methods and systems consistent with the present invention may contain additional or different components.

FIG. 1 illustrates a program 25 at the server 20, which is a request handling program, and which receives a client request from the client 10, i.e., in a communication session between the server 20 and the client 10 for providing a particular service to a user operating the client 10.

The request handling function could also be realized as a dedicated hardware device. The functionalities of the request handling may also be realized at a server, such as the server 20 of FIG. 1. Preferably, the program 25 communicates with a large number of clients 10 and with a large number of application programs, i.e., residing on one or a plurality of servers 20.

The client request receiving function, and the client request redirection transmission function may also be constituted by programs (i.e., program 25) providing the above outlined functionality, executed on a general purpose data processing device or a dedicated data processing device or means.

If realized in hardware, the client request receiving function may be handled by a receiver suitably connected to a communication link to the client 10, i.e., defined by an address and a port number. Similarly, the client request redirection transmission function may be conducted by a transmitter suitably connected to a communication link to the client 10. It is possible that the receiver and transmitter are separate units connected to the request handling hardware device.

The program 25 generates first redirection instructions based on the client request received from the client 10 and, transmits the first redirection instruction to a request handling application, instructing the program 25 to transmit the client request to another application, such as program 29, for serving the client request.

The program 29 may include a computing unit for performing the required computations in determining whether a further application program should be involved in serving the client request. The program 29 provides application redirection for reaching the basic decision on the necessity of a redirection. Alternatively, the program 29 may also select a specific secondary application program from a group of secondary application programs in the redirection process.

In program 29, the client request receiving function, the redirection function and the transmission functions may be realized as separate programs or may be realized by a dedicated hardware device or means. The hardware device may include a receiver suitably connected to a communication link to the client 10, i.e., defined by a an address and a port number. Similarly, the transmission function may be a carried out by transmission means, or a transmitter suitably connected to a communication link to the client 10.

Further, the receiving function, redirection function, and transmission functions, may form part of the program 29.

It is also possible that the functions of program 29 and its receiving, redirection, and transmission functions, are realized by a server 20, or more than one server.

After program 29 has determined if a redirection function is involved, the program 25 receives a redirection instruction from program 29, and program 25 forwards the client request to another application, such as program 31, upon receiving the first redirection instruction from program 29.

Thus, if the program 25 determines that another application program, such as program 31 should handle at least part of the client request from the client 10 to the program 29, the necessary redirections of the client request is handled by the request handling program 25.

Program 31 may have a similar constitution as program 29, providing services in executing one of the above outlined applications. Program 31 may be a program executed at a processing unit or may be realized in hardware or a means providing predefined services. Program 29 preferably provides computationally intensive services in executing one of the above outlined applications, for example rendering operations or the like. The functions of program 31 may be realized by a server, such as the server 20, or be on a separate server.

The above described system may be used to execute an arbitrary application involving the client 10 and the application programs 25, 29, 31. Operations carried out at the program 25 may be suitably controlled through the client 10, i.e., by a user operating the client 10.

For example, programs 29 and 31 could form part of an application for editing a document. Program 29 could assume functions in retrieving a corresponding document, while program 31 could provide rendering operations, i.e., for providing information in a data format available at the client 10.

Since a communication link between the client 10 and the program 25 may have a low bandwidth, redirections are advantageously handled by program 25, avoiding additional communication load on the connection between the client 10 and the program 25 in redirecting client requests.

Further, a plurality of clients 10 may be connected to the server program 25, with programs 29 and 31 being preferably adapted to provide services to a large number of clients, either sequentially or simultaneously. Still further, the application programs 29, 31 may reside on a single server, i.e., server 20 of FIG. 1, or may be distributed onto a plurality of servers. Still further, the program 25 may be part of a server, i.e., server 20, or be constituted by a dedicated processing device.

In the event the programs 25, 29, 31 are on a single server, i.e., server 20, functionality of the programs 25, 29, 31 may be assumed by a central data processing unit 21 of the server 20 or by separate processing devices of the server 20.

Since the client 10 accesses only program 25, and not programs 29 and 31 directly, a secure system may be obtained at reduced efforts as compared to the prior art.

For example, program 25 could be provided with the functionality of a fire-wall, restricting access to programs 29 and 31. A firewall generally is a method for keeping a network secure. It can for example be implemented in a router that filters out unwanted packets, or it may use a combination of technologies in routers and hosts. Firewalls may be used to give users access to public networks in a secure fashion as well as to separate a company's public Web server from its internal network. They may also be used to keep internal network segments secure. A firewall, as known in the art, may be a packet filter allowing passing of only selected packets, i.e., packets with a specific IP-address and/or a specific port number. Further, firewalls may perform certain processing operations on any packet received from the outside (or inside), before it is transmitted to the local area network side (or to the outside).

Further, only the internal resource locator used in the communication session between the client 10 and program 29 may be transmitted via the potentially insecure communication link between program 25 and the client 10. However, the internal resource locator is unknown but to the client 10 and program 29, thus providing a further security measure. The external resource locator will only be transmitted within the local area network connecting program 29, program 25, and program 31.

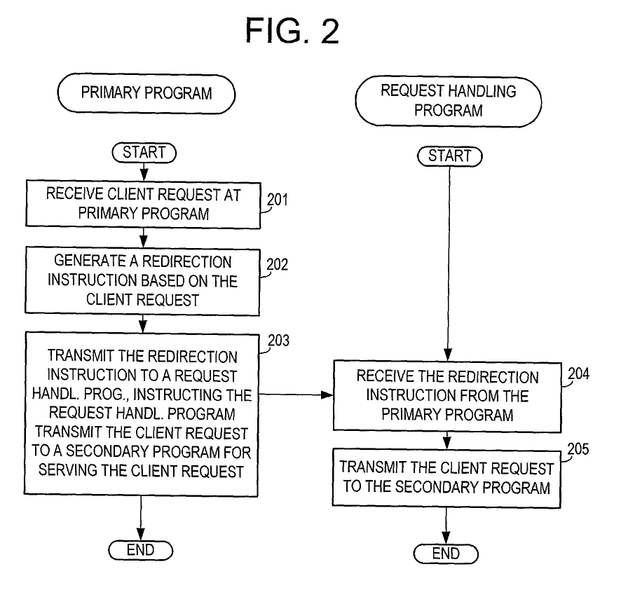

In the following a further embodiment consistent with the present invention will be described with respect to FIG. 2.

FIG. 2 depicts a flowchart outlining steps in a method of redirecting client requests in a client-server configuration according to one embodiment of the invention.

The operations illustrated in FIG. 2 may be carried out using the system shown in FIG. 1, however, FIG. 2 is not limited thereto.

It is assumed that the client 10 and the program 25 at server 20, have initialized a communication session for providing a service to a user.

On the left-hand side of FIG. 2, program operation at program 29 is shown, and on the right-hand side of FIG. 2, program operation carried out at program 25 is shown.

In a step 201, the program 29 of FIG. 1, receives a client request. The client request may be directly received from a client such as client 10, circumventing program 25, or may be indirectly received, for example, through program 25 of FIG. 1, memory 24 with program 25 being connected to the client 10 via a low bandwidth communication link.

The request, as outlined above, may be generated by a user operating the client 10 in order to obtain a particular service from a remote location. The client request may preferably specify a desired resource, such as an operation in an application as outlined above, for example retrieving a document for editing, rendering a document and the like.

In step 202, program 29 generates a redirection instruction based on the client request. The redirection instruction may for example, be generated upon the program 29 analyzing the client request and determining that the program 29 is not responsible for serving the client request or that a further application program should be involved in serving the client request.

In step 203, the program 29 transmits the redirection instruction to request handling program 25, instructing program 25 to redirect the client request. For example, program 25 could be instructed to transmit the client request to another application program, such as program 31 depicted in FIG. 1, for serving the client request.

In step 204, the program 25 receives the redirection instruction from program 29. A communication between program 25 and program 29 may be realized via internal connections, i.e., in the server 20, or through external communication links, if the program 25 and program 29 reside on separate servers.

In step 205, program 25 transmits the client request upon receiving the redirection instruction, if necessary, suitably modified (i.e., in correspondence to the redirection instruction or further processing steps carried out at the program 25), to another application program such as program 31 depicted in FIG. 1.

Thereafter the flow of program operations ends. Alternatively, further requests from the client 10 may be served, either by the program 29 or, after redirection, at program 31.

In the above embodiment, since the program 25 is instructed with the redirection instruction from the program 29 to transmit the client request to program 31 for serving the client request, the client 10 performing the redirection of the client request can be avoided, and therefore, additional communication load on a communication link between the client 10 and the program 25/program 29 will not be generated. The redirection of client requests may be performed using program 25 and communication links between the programs 29, 31 and program 25, which generally will be high bandwidth connections.

It is noted that the above described features and processing operations may be realized by dedicated hardware or may be realized as programs including code instructions executed on data processing units, i.e., a plurality of servers, and clients such as client 10. It is further possible that parts of the above sequences of operations are carried out in hardware, whereas others of the above processing operations are carried out using software.

It is further noted that a computer readable medium may be provided, having a program recorded thereon, where the program is to make a computer or system of data processing devices execute functions of the above described operations, particularly of the client and/or the server. A computer readable medium can be a magnetic or optical or other tangible medium on which a program is recorded, but can also be a signal, e.g., analog or digital, electromagnetic or optical, in which the program is embodied for transmission.

Further, a computer program product may be provided comprising the computer readable medium.

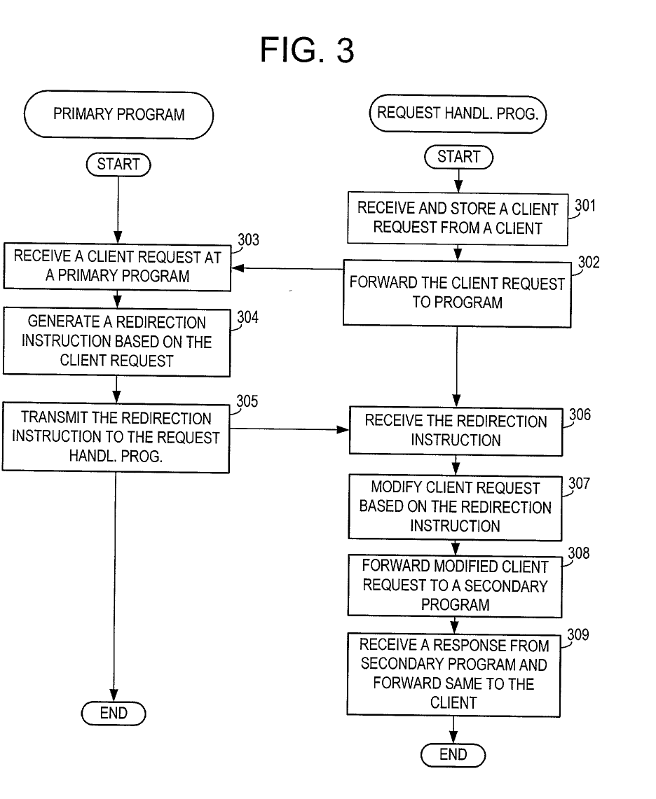

In the following a further embodiment consistent with the present invention will be described with respect to FIG. 3.

FIG. 3 depicts a flowchart outlining the steps in a method for redirecting client requests according to another embodiment consistent with the present invention.

The operations outlined with respect to FIG. 3 may be carried out using the system shown in FIG. 1, however, FIG. 3 is not limited thereto.

On the left-hand side of FIG. 3, program operations carried out at programs 29, 31 are illustrated, and on the right-hand side of FIG. 3, program operations carried out at program 25 are illustrated.

In a first step 301 at program 25 as shown in FIG. 1, program 25 receives a client request from a client, such as client 10 of FIG. 1, and intermediately stores or buffers the client request. The client 10 may be connected to the program 25 via an external communication link, such as a network connection, and/or a connection via a dedicated communication line and/or including wireless communications. The communication link between the client 10 and program 25 may have low bandwidth.

As outlined before, the request from the client 10 may specify a requested resource by including a resource identifier and a requested action such as receiving or providing data and the like. For example, the client request could be generated using a browser for browsing information on a communications network, such as a local area network or the Internet. In this case, a user may generate the request by i.e., clicking on a hyperlink on a display at the client 10, instructing the browser to generate a corresponding request. This may involve a request to display information, retrieve information, may include an instruction to start an application as outlined above, such as editing a document, spread sheet applications, mathematical operations and the like.

The client request may also specify an address of a device hosting the program 29, such as the server 20 or another separate server. The client request may also include information directly specifying the program 29.

In step 302, after receiving the client request and, if necessary, selecting or determining the target entity for the client request such as program 29, the program 25 forwards the client request to memory 28 having program 29.

Forwarding the client request may utilize internal connections if the programs 25 and 29 reside on the same physical entity, or may include external communication links, i.e., via a network or dedicated communication links, as outlined above. In this case a further routing of the client request through further elements of a communication network (not shown) may be involved.

In step 303, program 29 receives the client request.

In step 304, program 29 generates a redirection instruction based on the client request, i.e., if program 29 decides that it is not responsible for serving the request or if it decides that a further application program should be involved in serving the request.

In step 305, program 29 then transmits the redirection instruction back to memory 24 having program 25. As before in step 302 this may involve internal connections or external communication links, if the application program 29 and the program 25 reside on different servers.

In step 306, the program 25 receives the redirection instruction. Preferably, the redirection instruction includes information specifying that the program 25 is selected for redirecting the client request to program 31. This information, i.e., a flag, may be included a header field of the redirection instruction. Thus, program 25 may analyze the header of the request and based thereon, proceed to redirect the client request.

If the redirection does not specify a selection of the program 25 for redirecting the client request, the redirection instruction may be transmitted to the client 10 which then may perform the redirection of the client request to another application or program.

However, it may also be agreed upon that the program 25 is responsible for all redirections based on redirection instructions.

After receiving the redirection instruction and, i.e., determining, that the program 25 is responsible for redirection, in step 307, the program 25 may further analyze the redirection instruction, and, based on information of the redirection instruction, the program 25 may modify the client request.

The modification may involve including address information of memory 28 having program 31 into the client request, for example, as specified in the redirection instruction. Further, the program 25 may further specify the requested resource of the client request, for example, in a case where the program 29 decides to serve a first part of the client request. In this case, the redirection instruction preferably specifies a second part of the client request to be served by program 31, and program 25 correspondingly modifies the client request to specify the second part of the client request only. This may involve modifying a resource identifier included in the client request.

However, it is also possible that the redirection instruction only instructs program 25 to redirect the intermediately stored client request from the client 10, and leaves it up to program 25 to select program 31, for example, based on information of available application programs.

In step 308, program 25 forwards the modified client request to memory 28 having program 31. The client request may be forwarded via internal connections, if programs 25 and 31 reside on the same server, or may be achieved involving external communication links, if program 25 and program 31 reside on different physical entities.

After receiving the client request, program 31 processes the request. This may involve performing functions in one of the applications outlined with respect to previous embodiments, such as retrieving data, rendering operations, and the like.

Program 31 then generates a suitable response to the client request. The response may include data to be transmitted to the client 10 or may include a notification for the client 10 that a specified request was served, i.e., by storing data, or performing further operations.

In step 309, the response from program 31 is received at program 25 and forwarded to the client 10.

Even though the operations of the current embodiment are shown in a particular sequence, the invention is not limited to the specific sequence shown. The person skilled in the art readily appreciates that some variations of the sequence of operation are possible without departing from the invention.

In the above outlined embodiment the request handling program 25 channels all requests and responses in executing the application. The client 10 only communicates with program 25 in transmitting client requests and receiving responses to client requests.

In case program 25 decides on serving a part of the client request, while redirecting for a second part of the client request, the program 25 could forward responses from program 29 and program 31 to the client 10.

As in the previous embodiments, since a redirection of client requests is performed by the program 25, a potentially low bandwidth connection between the client 10 and the program 25 is not subjected to further communication load due to the redirection of the client request.

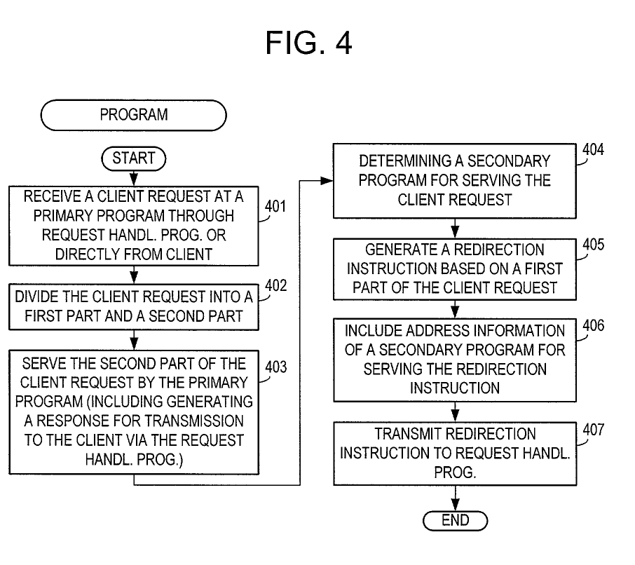

In the following a further embodiment consistent with the present invention will be described with respect to FIG. 4.

FIG. 4 depicts a flowchart and method steps in a sequence of operations for redirecting client requests at memory 28 according to another embodiment consistent with the present invention. The operations of FIG. 4 may be carried out by the system shown in FIG. 1, however, FIG. 4 is not limited thereto.

The embodiment of FIG. 4 particularly outlines steps performed at program 29 in serving a client request, including dividing the client request into different parts for service at program 29 and program 31, and selecting program 31.

In a first step 401, a client request is received at program 29, i.e., through program 25 or directly from the client 10, as outlined with respect to previous embodiments.

In step 402, the program 29 analyzes the request and divides the request into a first part and a second part. The first part and the second part may be associated with different processing steps to be executed in connection with the client request, for example the first part of the client request could relate to retrieving a document for editing, and the second part could relate to editing the document or the like.

As an example, in the present embodiment, it is assumed that the application program 29 decides that the first part of the client request should be served at program 31, whereas the second part of the client request can be served at the program 29.

In accordance therewith, in step 403, the second part of the client request is served by the program 29, which may include generating a response for transmission to the client 10. The response may be transmitted via the program 25 of FIG. 1.

Further, the program 29 in step 404, determines that program 31 is to serve the first part of the client request, for example as outlined before. For example, program 29 may select program 31 based on a list of available application programs for serving the first part of the client request. If a plurality of potential candidate programs are available, one of the programs could be selected for program 31, i.e., based on load balancing considerations for balancing the communication load in a network. Program 31 may be located at the same server 20 as program 25, or preferably, may be located close by.

Thus, the program 25 may determine program 31 for serving the client request based on a list of available application programs, and may add to the redirection instruction address information on the program 31 for serving the client request.

In step 405, the program 29 generates a redirection instruction based on the first part of the client request and, in step 406 includes address information on the program 31 for serving the redirection instruction.

In step 407, the program 29 transmits the redirection instruction to program 25, which may, upon receiving the redirection instruction from the program 29, if necessary, modify the client request as outlined before, and redirect the client request to program 31 for service, as also outlined with respect to previous embodiments.

The embodiment of FIG. 4 allows program 29 to serve part of the client request, while another part of the client request is suitably redirected to program 31.

The redirection instruction is generated based on a first part of the client request, and a second part of the client request is served by program 29, which may include generating a response for transmission to the client 10 via program 25. The redirection, as in the previous embodiments, involves program 25 and therefore, allows to avoid further communication load on the potentially low bandwidth connection between the client 10 and program 25/programs 29, 31.

It is noted that in the embodiment of FIG. 4 not necessarily all the steps are always needed. Examples are possible, where some steps are omitted. For example, if the entire request is to be redirected, steps 402 and 403 may be omitted. Further, if the selection of program 31 is to be performed by program 25, step 404 may be omitted.

Further, even though the steps of the current embodiment are shown in a particular sequence, the invention is not limited to the specific sequence shown. The person skilled in the art readily appreciates that some variations of the sequence of operation are possible without departing from the invention.

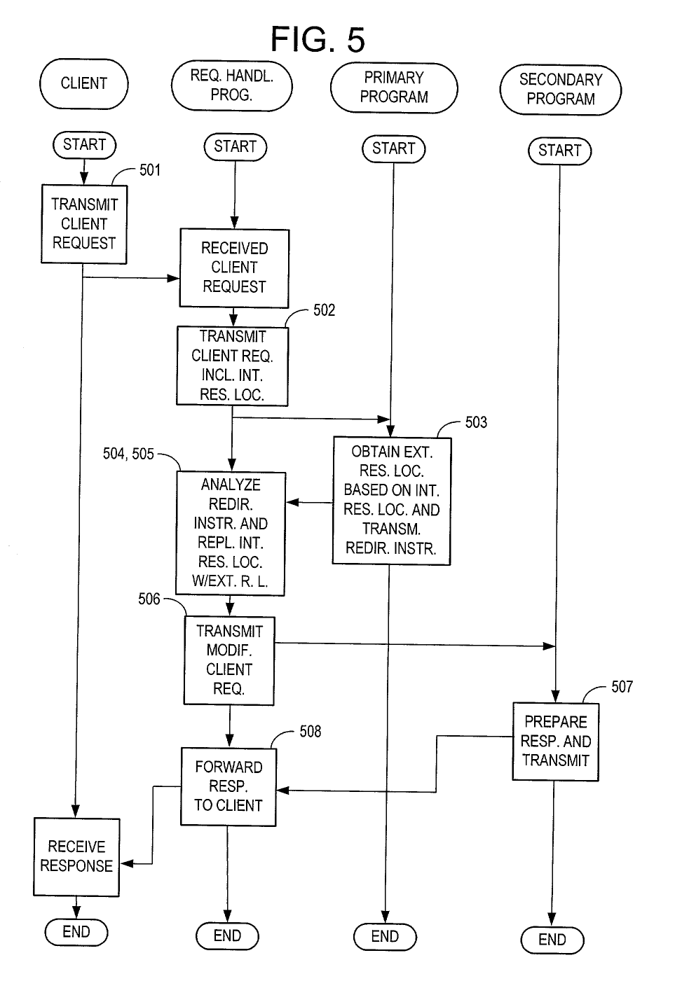

In the following a further embodiment consistent with the present invention will be described with respect to FIG. 5.

FIG. 5 depicts a flowchart of steps in a method of redirecting client requests according to a further embodiment consistent with the present invention.

The embodiment shown in FIG. 5 is similar to the embodiment shown in FIG. 1. In addition to the elements shown in FIG. 1, memory 28 includes a resource locator table.

Further, the memory 28 with program 29 and resource locator table are preferably part of a single server.

Still further, program 25 is preferably part of a data processing system on another server, and program 31 is preferably part of a data processing system on a third server.

Thus, the programs 29, 31 and program 25 may each be located on different physical entities and may be interlinked via communication networks or dedicated communication links as outlined above.

However, this is an example only, and, as outlined with respect to the embodiment of FIG. 1, the programs 29, 31 may reside on a single server. As a further alternative this single server may include the program 25.

Further, it is possible that program 29 and program 25, or program 31 and program 25 may reside on a single unit.

Elements with the same reference numerals as in FIG. 1 have the same functionality and for brevity reasons it is referred to the embodiment of FIG. 1 in connection with these elements. However, with respect to some elements further details are given in the following.

In the present embodiment consistent with the present invention, the client 10 and program 29 are assumed to be involved in a communication session involving program 25, the program 25 for example, forwarding client requests from the client 10 to the program 29 and responses from program 29 to the client 10. As outlined before, the client requests transmitted from the client 10 to the program 29 may include resource locators specifying a resource at the program 29 such as a step to be performed in retrieving a document, editing a document, performing rendering operations and the like.

In step 501, the client 10 transmits a client request to the program 25. The client 10 may be connected to the program 25 via an external communication link, such as a network connection, and/or a connection via a dedicated communication line and/or including wireless communications. The communication link between the client 10 and the program 25 may have low bandwidth.

In step 502, the program 25 transmits the client request to the program 29.

As the communication link between the client 10 and the server 50 having program 25 may have a low bandwidth, as outlined before, i.e., due to using a low bandwidth wireless connection, low bandwidth network connection or fixed communication link, it is desirable to maintain the requests as short as possible. Therefore, instead of transmitting full length resource locators, such as uniform resource locators used in the HTTP environment or resource locators used according to any other protocol, abbreviated resource locators may be used in the communication session between the client 10 and the program 29.

An external resource locator may, for example, be a Uniform Resource Locator (URL) or any other resource locator used to specify a resource in a communications network such as a local area network or a wide area network. A resource locator may specify an identifier of an entity of the network able to provide the requested resource, or may directly specify an address of a device such as a server. As extenial resource locators are preferably composed according to an agreement valid for all devices of a network, any device may understand, i.e. suitably handle, an external resource locator.

Thus, instead of transmitting externally known resource locators, i.e., external resource locators, from the client 10 to the program 25 in client requests, the client 10 and the program 29 in the shown embodiment agree on internal resource locators in correspondence to full length external resource locators. Accordingly, a client request will include an internal resource locator, specifying a resource available through the program 29.

The program 29 may keep track of such corresponding internal resource locators and external resource locators in a resource locator table. The resource locator table may therefore, include a list of external resource locators and corresponding internal resource locators used in the “private” communication session between the client 10 and the program 29.

Accordingly, the client request includes an internal resource locator previously transmitted from the program 29 to the client 10 and specifying a requested resource, the internal resource locator being valid in a communication between the program 29 and the client 10.

However, in this scenario, if the program 29 determines that it is not or not alone responsible for serving a client request and decides to redirect at least part of the client request to another communication program such as program 31, the second program 31 is not aware of which resource is linked to the internal resource locator used in the communication session between the client 10 and program 29.

Therefore, upon receiving a client request at program 29, including an internal resource locator and requiring a redirection through program 25, in step 503, the program 29 obtains an external resource locator based on the received internal resource locator, the external resource locator preferably allowing program 31 to access the requested resource.

The program 29 may therefore, include into the redirection instruction, the external resource locator corresponding to the internal resource locator received with the client request and will transmit the redirection instruction to the program 25 in step 503.

Preferably, the redirection function of program 29 may be adapted to obtain an external resource locator based on the internal resource locator, the external resource locator allowing program 31 to access the resource and to include the external resource locator into the redirection instruction.

The program 25, receiving the redirection instruction, in step 504, will analyze the redirection instruction and replace in the client request received from the client 10 the internal resource locator by the external resource locator received with the redirection instruction.

Further, the program 25 may modify the client request as outlined with respect to previous embodiments. The redirection may include the program 29 instructing the program 25 to modify the client request based on information included in the redirection instruction.

Preferably, the program 25 is instructed by program 29 in step 505 to replace the internal resource locator by the external resource locator and/or include address information of program 31 into the client request.

In step 506, program 25 then transmits the modified client request to program 31 for serving the request, as outlined with respect to previous embodiments.

In step 507, program 31 will prepare a response and transmit same to program 25.

In step 508, program 25 will forward the response to the client 10 for local display of information included in the response or further processing operations, as outlined with respect to previous embodiments.

As an alternative, it is also possible that if program 29 already serves part of the client request, that the program 29 includes an external resource locator corresponding to a second part of the client request into the redirection instruction transmitted to the program 25 as noted above in step 503.

The resource locator table may be constituted by a storage device accessible through program 29, i.e., a memory 28 of the server. Alternatively, the resource locator table may be located on a separate device located remote from the program 29 and the server.

The embodiment outlined with respect to FIG. 5 allows further reduction of a communication load between the client 10 and the request handling/application programs, as in the communication session between the client 10 and the application programs, internal resource locators may be used, the internal resource locators having shorter length than external resource locators, i.e., uniform resource locators URL, used according to, for example, the HTTP protocol. It is noted that the present invention is not limited to the HTTP protocol, the invention may be applied to any other protocol specifying resource locators.

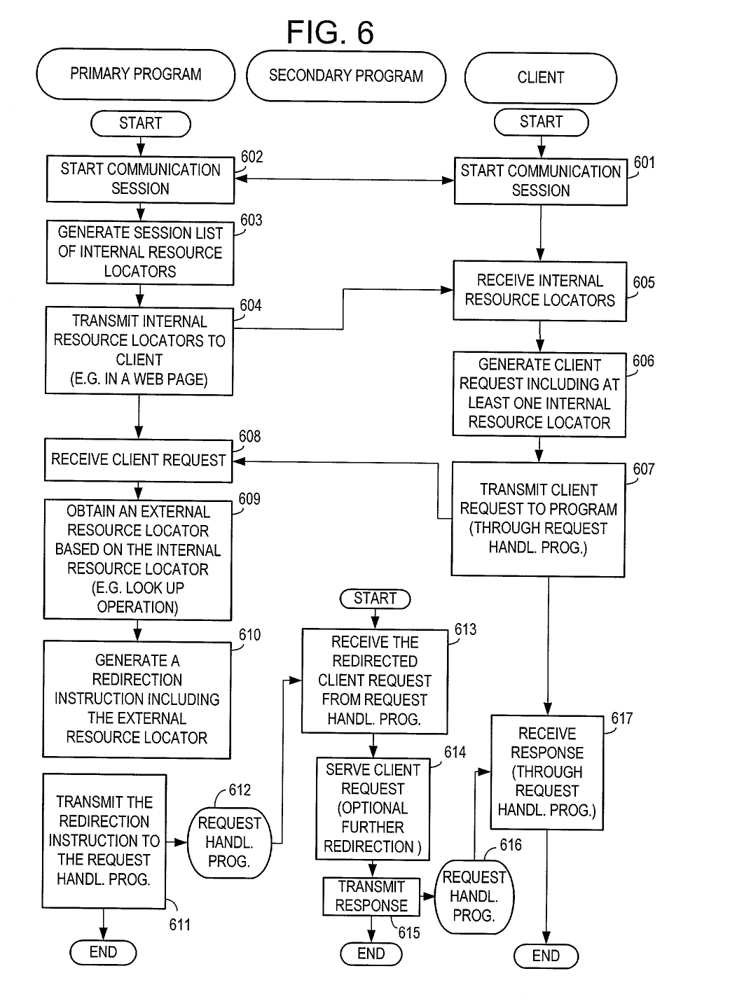

In the following a further embodiment consistent with the present invention will be described with respect to FIG. 6.

FIG. 6 is a flowchart depicting the steps for redirecting client requests according to another embodiment consistent with the present invention. In FIG. 6, steps at program 29, program 31, and the client 10, are further outlined in detail. The steps illustrated in FIG. 6 may be executed using the system illustrated in FIG. 1 or as described in FIG. 5, however, FIG. 6 is not limited thereto.

On the left-hand side of FIG. 1, the steps are illustrated which are carried out at program 29. In the middle column of FIG. 6, steps are illustrated which are carried out at program 31. On the right-hand side of FIG. 6, steps at the client, such as client 10 shown in FIG. 1 or described in FIG. 5, are illustrated.

In a first step 601, and in step 602, a communication session is initialized between the program 29 and the client 10. Establishing a communication session may involve dialing into a network from the client 10 and transmitting information between the program 29 and the client 10 through a program 25 as shown in FIG. 1 or described in FIG. 5. The communication session may be established by a user who wishes to obtain a service at a server 20 remote from a client 10 operated by the user.

The communication session may involve executing a browser application for browsing information on a computer network at the client 10. The communication session may include applications for editing a document, displaying information, spread sheet applications, rendering operations and the like, as outlined with respect to previous embodiments.

In step 603, the program 29 generates a session list of internal resource locators, i.e., internal resource locators which may be used during the communication session.

For example, it is conceivable that in a communication session a page for display at the client 10 is to be prepared, the page including a plurality of links to resources, the links being specified by external resource locators, for example if a directory tree of a website is to be graphically displayed.

In this situation a list of internal resource locators could be created, each one internal resource locator corresponding to an external resource locator of the above links. For example, the external resource locators could be listed at locations specified by addresses, the addresses constituting internal resource locators.

Thereafter, in step 604, the program 29 transmits the session list of internal resource locators or some of the internal resource locators of the session list to the client 10, for example in a page to be displayed at the client 10, i.e., a page visualizing a directory of a website. The internal resource locators may be transmitted in a web page, i.e., as used according to the HTTP protocol in a network environment.

In step 605, the client 10 receives the internal resource locators, which may thereafter be used in the communication session with the program 29 for generating client requests. Since the internal resource locators are much shorter than external resource locators such as uniform resource locators URL as for example, used in the HTTP environment, a communication load generated by client requests in the communication session between program 29 and the client 10 may be maintained low.

In step 606, the client 10 generates a client request including at least one of the internal resource locators received from the program 29. As outlined before, the request may for example, be generated by a user clicking on a respective link in a web page or may be generated by any other means.

In step 607, the program 25 transmits the client request to the program 29. The client request may thus, include at least one of the internal resource locators previously transmitted from the program 29 to the client 10 and specifying a requested resource, the internal resource locator being valid in a communication between the program 29 and the client 10.

As outlined with respect to previous embodiments, the program 25 may handle any communication between the program 29 and the client 10.

In step 608, the program 29 receives the client request.

Then, in step 609, the program 29 obtains an external resource locator based on the internal resource locator received with the client request, as outlined before. For example, in a lookup operation using the internal resource locator, the external resource locator corresponding to the internal resource locator could be identified.

Thus, the program 29 may obtain an external resource locator based on the internal resource locator, the external resource locator allowing the program 31 to access the resource.

The program 29 may be adapted to perform the look-up operation in a resource locator table associating internal resource locators and external resource locators at least used by the program 31, the primary resource locator constituting an address for indexing into the resource locator table to identify the external resource locator.

The internal resource locator may constitute an address for indexing into a list of external resource locators to identify the external resource locator corresponding to the internal resource locator. Further, as outlined before, obtaining the external resource locator may not necessarily be a one to one translation of an internal resource locator received with a client request, particularly in cases where the program 29 already serves part of the client request, the external resource locator, in this case corresponding to a part of the client request, could be suitably selected.

In step 610, the program 29 generates a redirection instruction including the external resource locator identified in step 609. Further, the redirection instruction may include information on program 31, if program 31 is already selected at the program 29.

In step 611, program 29 transmits the redirection instruction to program 29. At program 25, if program 31 is not already selected at program 29, and information on program 31 is not included in the redirection instruction, program 25 selects a program in step 612, i.e., from a list of available secondary application programs for serving the client request, such as program 31. Program 25 then redirects the, if necessary, suitably modified client request, to the program 31, where it is received in step 613.

In step 614, the client request is served at program 31, as outlined before. Further, serving the client request may included a further redirection according to the above scheme, if program 31 determines that a further application program should serve the client request.

In step 615, as outlined before, the program 31 transmits a suitable response to program 25 which forwards the response in step 616 to the client 10.

In step 617, the response is received at the client 10, as outlined before. This may include visualizing information received in the response, or may include further processing and similar. Thereafter the flow of operation ends.

The embodiment outlined with respect to FIG. 6 allows a further reduction of a communication load on a potentially low bandwidth communication link between the client 10 and the request handling program/application programs, as in a communication session, abbreviated resource locators are used, and additionally thereto, a redirection of client requests at the program 25 is possible, since external resource locators are included into the redirection instructions from the program 29 to the program 25.

Even though the operations of the current embodiment are shown in a particular sequence, the invention is not limited to the specific sequence shown. The person skilled in the art readily appreciates that some variations of the sequence of operation are possible without departing from the invention.

It is noted that the above described features and processing operations may be realized by dedicated hardware or may be realized as programs including code instructions executed on data processing units, i.e., servers as server 20 etc. and clients such as client 10. It is further possible that parts of the above sequences of operations are carried out in hardware, whereas others of the above processing operations are carried out using software.

It is further noted that a computer readable medium may be provided, having a program recorded thereon, where the program is to make a computer or system of data processing devices execute functions of the above described operations, particularly of the client and/or the server. A computer readable medium can be a magnetic or optical or other tangible medium on which a program is recorded, but can also be a signal, i.e., analog or digital, electromagnetic or optical, in which the program is embodied for transmission.

Further, a computer program product may be provided comprising the computer readable medium.

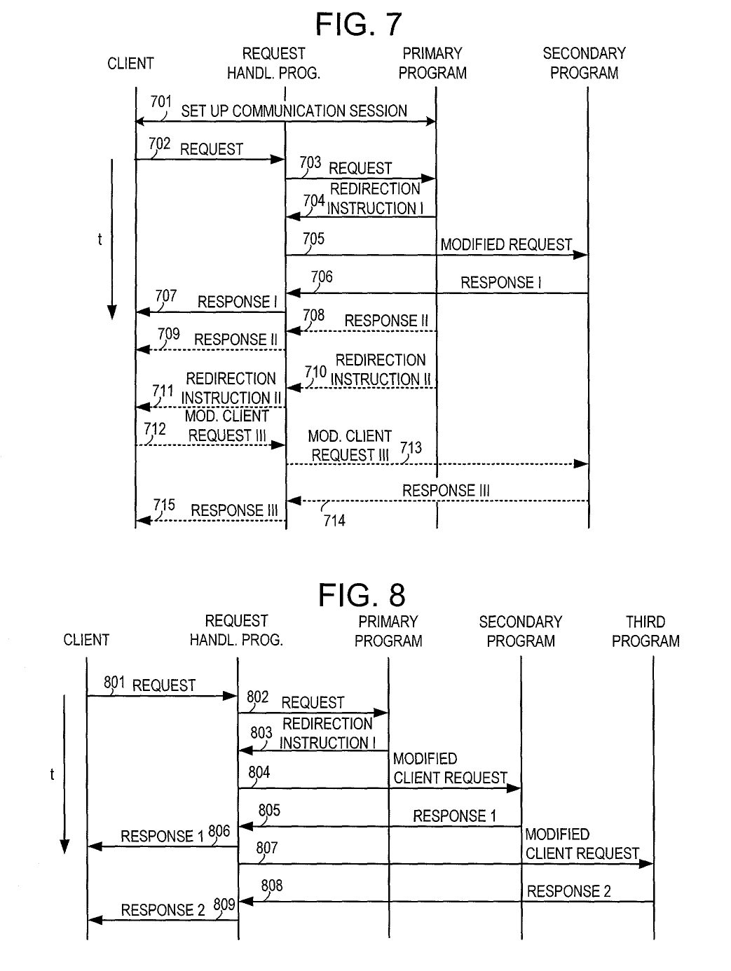

In the following a further embodiment consistent with the present invention will be described with respect to FIG. 7.

FIG. 7 shows a time sequence of operations for redirecting client requests according to another embodiment consistent with the present invention.

FIG. 7 particularly outlines a flow of information between a client 10, a program 25, a program 29, and a program 31, for example as shown in FIG. 1 or as described with respect to FIG. 5. However, FIG. 7 is not limited to the embodiments of FIG. 1 or 5.

In FIG. 7 time evolves in downward direction, as indicated in the Figure.

In step 701, a communication session is set up between a client 10 and a program 29. For example, setting up the communication session may include transmitting a request from the client 10 to the program 29, instructing the program 29 to prepare the set-up of the communication session at the side of the program 29, i.e., a server 20.

Subsequent thereto, program 29 may transmit a response to the client 10, subsequent to which the client 10 prepares the set-up of the communication session with the program 29.

Thereafter, the communication session involving the program 29 and the client 10 can be established.

The communication session may also be set up as outlined with respect to previous embodiments.

In step 702, the client 10 transmits the client request from the client 10 to the program 25. The client 10 may be connected to the memory 24 with program 25 via an external communication link, such as a network connection, and/or a connection via a dedicated communication line and/or including wireless communications. The communication link between the client 10 and the program 25 may have low bandwidth. The client request may be constituted and transmitted to the program 25 as outlined with respect to previous embodiments.

In step 703, the program 25 forwards the request to program 29, where it may be suitably analyzed in preparation of generating a first redirection instruction. As outlined with respect to previous embodiments the redirection instruction may correspond to the entire client request or may correspond to part of the client request.

In step 704, program 29 transmits the redirection instruction to program 25 and the program 25 then suitably modifies the client request received from the client 10 in step 702, as outlined before. The modifying operation, if necessary, may be carried out as outlined with respect to previous embodiments. A modification may not be necessary, if the client request already includes an external resource locator.

In step 705, the program 25 transmits the modified client request to the program 31. The program 31 then performs the required operations for serving the client request, as outlined before, and, in step 706, transmits a first response to the program 25. The program 25 forwards the first response to the client 10 in step 707.

Optionally, the further steps 708-712 outlined by dashed lines may be executed in the embodiment of FIG. 7.

Particularly, if the client request is divided into a first part and a second part wherein one part is already served at the program 29, the program 29 may directly transmit a second response in step 708 to program 25, and the program 25 in step 709 may forward this second response to the client 10. Thus, the program 29 may directly serve at least part of the client request without redirection.

Further, in step 710, the program 29 may generate a second redirection instruction for transmission to the client 10. In this second redirection instruction the client 10 is specified as addressee for redirecting the request and therefore the program 25 only forwards the second redirection instruction to the client 10 in step 711.

In step 712, upon receiving the second redirection instruction, i.e., a redirection instruction corresponding to part of the original client request as transmitted in step 702, the client 10 transmits a modified client request to the program 25. This modified client request preferably specifies a secondary application program such as program 31 shown in FIG. 7.

Therefore, in step 713, the program 25 forwards the modified client request to the program 31. A third response, i.e., the response to the modified client request received in step 713 at the program 31, will be transmitted to the program 25 in step 714, and in an operation 715, the program 25 will transmit the third response to the client 10 for further handling.

As outlined with respect to FIG. 7, various scenarios in serving a client request are possible, including serving the entire client request at the program 29, redirecting the entire client request or parts thereof to program 31 either via the request handler or the client 10.

In the following, a further embodiment consistent with the present invention, will be described with respect to FIG. 8. FIG. 8 outlines a time sequence operation in redirecting client requests according to another embodiment consistent with the present invention.

FIG. 8 particularly outlines operations at a client 10, a program 25, a program 29, and a program 31, for example as illustrated in FIG. 1 and described with respect to FIG. 5. Further, FIG. 8 outlines further steps at a third application program 33.

In step 801, the client program 15 transmits a client request to the program 25, as outlined before.

In step 802, the program 25 forwards the request to program 29.

In step 803, the program 29 generates a first redirection instruction and transmits it to the program 25.

In step 804, the program 25 suitably modifies the client request received in step 801, and the modified client request is transmitted to program 31, as outlined with respect to previous embodiments.

In step 805, the program 31 generates a first response and transmits same to the program 25.

The program 25 forwards the first response in step 806 to the client 10.

Further, the program 25 may transmit a further modified client request to the third application program 33, for example, based on the first redirection instruction received from the program 29 in step 803.

However, alternatively, it is also possible that the further modified client request transmitted from the program 25 to the program 33 in step 807 is generated based on a second redirection instruction (not shown) received at the program 25 from the program 31.

The program 33, upon receiving the modified client request, generates a suitable response and transmits same to the program 25 in step 808.

The program 25 then forwards the second response in step 809 to the client 10.

The embodiment of FIG. 8, as the embodiment shown in FIG. 7, allows the maintenance of a communication load between a client 10 and a program 25 at a low level while performing a redirection of client requests as necessary.

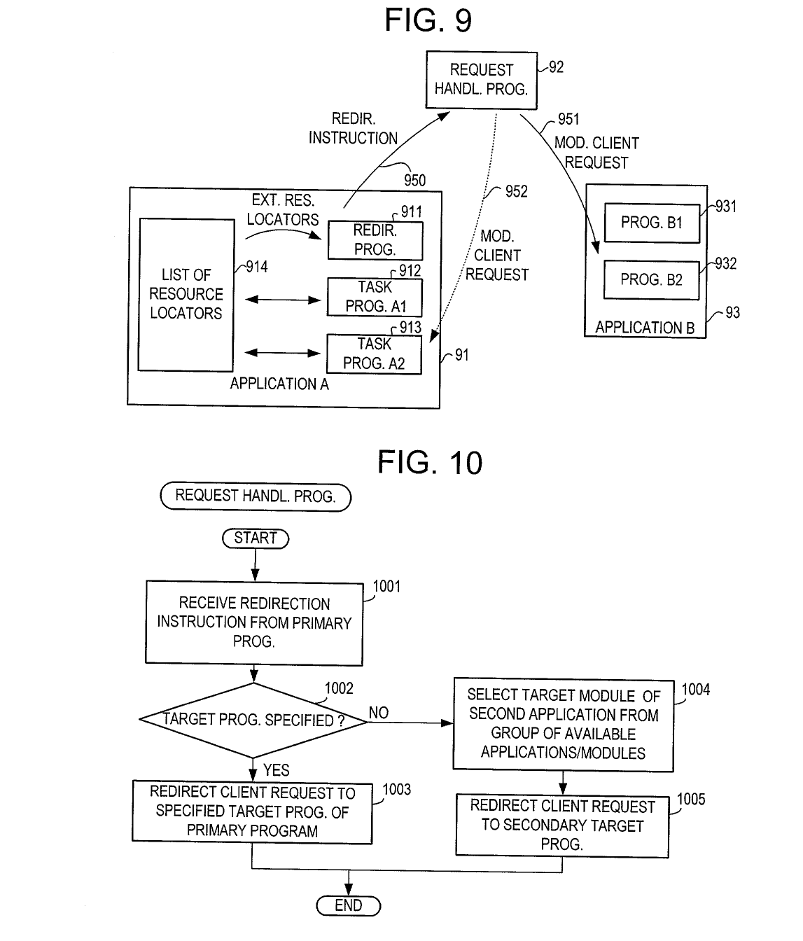

In the following, a further embodiment consistent with the present invention will be described with respect to FIG. 9.

FIG. 9 shows elements of a system for redirecting client requests according to another embodiment consistent with the present invention. FIG. 9 shows a first application program 91, a request handling program 92 and a second application program 93. A client (not shown) or a plurality of clients may communicate with the request handling program 92.

The application program 91 includes a plurality of modules or sub-programs, including a redirection program 911, a first task program 912, and a second task program 913. Further, the primary application program 91 includes a list of resource locators 914, for example as outlined with respect to previous embodiments.

The secondary application program 93 is shown to include a first program 931 and a second program 932.

Similar to the program 25 outlined with respect to FIG. 1, the above modules/programs and the applications 91 and 93 may be realized by dedicated hardware devices. It is also possible that the functions of the application programs 91 and 93 and the elements of the above programs/hardware devices are realized by a server such as the server 20 or others as described with respect to FIG. 1.

The request handling program, the first application program and the second application program may be located on separate data processing units. Alternatively, the request handling program and the first application program may be located on a single server. This server may also include the second application program.

In the following the elements of the first application program will be outlined in further detail.

The first application program 91 includes a redirection program 911 performing functions for redirecting client requests, as outlined with respect to previous embodiments. The first and second task programs of the first application program 91 may provide a certain functionality in providing a service for a user operating a client, such as retrieving documents, displaying documents, rendering documents and similar.

The first task program 912 and the second task program 913 both have access to the list of resource locators 914. In a communication session between a client and the first application program 91, the task programs 912 and 913 may therefore, introduce elements into the list of resource locators. This may include providing internal resource locators corresponding to external resource locators, as outlined with respect to previous embodiments.

Thus, in a communication session between the client and the first application program 91, the task programs maintain and update the list of resource locators, as appropriate.

If in this scenario a redirection of a client request or parts thereof becomes necessary, the redirection program 911 generates redirection instruction based on the list of resource locators. Preferably, the redirection program includes into a redirection instruction an external resource locator corresponding to an internal resource locator previously received with a client request. The redirection program then transmits the redirection instruction to the request handling program 92, as indicated by an arrow 950.

The request handling program 92 forwards the client request as shown by arrow 951, i.e., modified as outlined with respect to previous embodiments, to the second application program 93, if necessary, further specifying one of the programs 931 and 932.

The further operations at the second application program 93 may be similar to the ones outlined with respect to previous embodiments, i.e., the second application program 93 and/or the programs 931 and 932 may generate a suitable response to the client request and transmit same via the request handling program to the client (not shown).

Alternatively, the request handling program may transmit a modified client request, as indicated by an arrow 952 back to the first application program 91. For example the modified client request may be transmitted to another task program specified, in the present case, task program 913.

Thus, a redirection instruction may be generated for a redirection to a task program of the first application program 91.

Accordingly, the request handling program may be used in forwarding a client request irrespective of the target program, i.e., the request handling program is responsible for forwarding a client request to a program of the same application or to a program of another application, i.e., another application located at the same server or a remote server.

In the following, a further embodiment consistent with the present invention will be described with respect to FIG. 10.

FIG. 10 shows operations for redirecting client requests at a request handling program according to another embodiment consistent with the present invention.

The steps of FIG. 10 may be performed using the systems of FIG. 1, as described in FIG. 5 or as depicted in FIG. 9; however, FIG. 10 is not limited thereto.

FIG. 10 particularly outlines steps for selecting a target program, if the target program for a redirection of the client request is not already specified in the redirection instruction.

In step 1001, a redirection instruction from a first application program is received by the request handling program.

In step 1002, the request handling program analyzes the redirection instruction and determines whether a target program is already specified in the redirection instruction, i.e., a target program selected by the first application program.

If the decision in operation 1002 is YES, indicating that a target program is specified in the redirection instruction, the request handling program transmits the client request to the specified target program. The target program is preferably specified in the redirection instruction, if the target program and the first program issuing the redirection instruction are part of the same application, as in this case it may be desired to avoid redirection to a program of another application, i.e., on another server.

If the decision in step 1002 is NO, indicating that the target program is not specified in the redirection instruction, the request handling operation in step 1004, selects a target program from a group of available applications/programs.

If a plurality of target programs suitable for serving the request are available, i.e., on a plurality of servers, the request handling program may also perform functionality of a load balancer, and therefore, the request handling program may apply load balancing algorithms in selecting a target program from the available target programs.

In step 1005, the request handling program then redirects the client request to the target program. Further operations may be similar as outlined with respect to previous embodiments.

It is noted that the above described features and processing operations may be realized by dedicated hardware or may be realized as programs including code instructions executed on data processing units, i.e., servers as server unit 20 etc, and clients such as client 10. It is further possible that parts of the above sequences of operations are carried out in hardware, whereas others of the above processing operations are carried out using software.

It is further noted that a computer readable medium may be provided, having a program recorded thereon, where the program is to make a computer or system of data processing devices execute functions of the above described operations, particularly of the client and/or the server. A computer readable medium can be a magnetic or optical or other tangible medium on which a program is recorded, but can also be a signal, i.e., analog or digital, electromagnetic or optical, in which the program is embodied for transmission.

Further, a computer program product may be provided comprising the computer readable medium.

According to another embodiment of the invention a server for redirecting client requests including a first application program may have the following elements.

1) A server for redirecting client requests including a first application program having

a code section containing instructions to receive a client request;

a code section containing instructions to generate a first redirection instruction based on the client request;

a code section containing instructions to transmit the first redirection instruction to a request handling program, instructing the request handling program to transmit the client request to a second application program for serving the client request.

2) The server of 1), including a code section containing instructions to determine the second application program for serving the client request based on a list of available application programs and to add to the redirection instruction address information of the second application program.

3) The server of 1), including

a code section containing instructions to receive the client request from the request handling program, the request handling program forwarding the client request from the client to the first application program; and

a code section containing instructions to include into the first redirection instruction information specifying that the request handling program is selected for redirecting the client request to the second application program.

4) The server of 1), wherein the client request includes an internal resource locator previously transmitted from the first application program to the client and specifying a requested resource, the internal resource locator being valid in a communication between the first application program and the client.

5) The server of 1), including a code section containing instructions to obtain an external resource locator based on the internal resource locator, the external resource locator allowing the second application program to access the resource and to include the external resource locator into the first redirection instruction.

6) The server unit of 1), including a code section containing instructions to perform a look-up operation in a resource locator table associating internal resource locators and external resource locators at least used by the second application program, the first resource locator constituting an address for indexing into the resource locator table to identify the second resource locator.

7) The server of 1), including a code section containing instructions to instruct the request handling program to modify the client request based on information included in the redirection instruction.

8) The server of 7), including a code section containing instructions to instruct the request handling program to at least one of:

replace the internal resource locator by the external resource locator; and

include address information of the second application program into the client request.

9) The server of 1), including a code section containing instructions to generate the first redirection instruction based on a first part of the client request, and wherein the first application program serves a second part of the client request is served.

10) The server of 1), including

a code section containing instructions to determine a third application program for serving a third part of the client request and to generate a second redirection instruction based on the third part of the client request; and

a code section containing instructions to transmit the second redirection instruction to the request handling program, instructing the request handling program to transmit a modified client request to the third application program.

11) The server of 1), including code sections containing instructions to execute the first and second application programs.

12) The server of 1), including a code section containing instructions to execute the first application program, and wherein the second application program is executed on a second server remote from the first server.

According to another embodiment of the invention, a request handling program may have the following elements.

13) A request handling program for redirecting client requests, including:

a code section containing instructions to receive a client request from a client;

a code section containing instructions to forward the client request to a first application program;

a code section containing instructions to receive a first redirection instruction from the first application program; and

a code section containing instructions to forward the client request to a second application program.

14) The request handling program of 13), including a code section containing instructions to forward a response to the first redirection request from the second application program to the client.

15) The request handling program of 13), wherein the first redirection instruction includes address information of the second application program and information specifying that the request handling program is selected for transmitting the first redirection instruction to the second application program.

16) The request handling program of 13), wherein the client request includes an internal resource locator previously transmitted from the first application program to the client and specifying a requested resource, the internal resource locator being valid in a communication between the first application program and the client.

17) The request handling program of 13), wherein the first redirection instruction includes an external resource locator associated with the internal resource locator, the external resource locator allowing the second application program to access the resource.

18) The request handling program of 13), including

a storage unit to intermediately store the client request; and

including a code section containing instructions to modify the client request based on information included in the redirection instruction.

19) The request handling program of 18), including a code section containing instructions for at least one of:

replacing the internal resource locator by the external resource locator; and

including the address information of the second application program into the client request.

20) The request handling program of 13), wherein

the first redirection request is associated with a first part of the client request, and

a second part of the client request is served by the first application program by transmitting a response to the client through the request handling program.

21) The request handling program of 13), including

a code section containing instructions to receive a third redirection request based on a third part of the client request; and

a code section containing instructions to transmit the third redirection request to a third application program for serving the third redirection request.

22) The request handling program of 13), including a code section containing instructions to determine a second application program for serving the client request, if the first application program and the second application program do not form part of a same application.

23) The request handling program of 13), including code sections containing instructions to communicate with a server data processing device executing the first and second application programs.

24) The request handling program of 13), including a code section containing instructions to communicate with a first server executing the first application program and with a second server executing the second application program.

While the invention has been particularly shown with reference to the above embodiments, it will be understood by those skilled in the art that various other changes in the form and details may be made therein without departing from the spirit and the scope of the invention.

What is claimed is:

1. A method in a data processing system of redirecting client requests at a server, in a client-server system, comprising the steps of:
receiving a client request from a client at a first application program;
generating a first redirection instruction based on said client request at said first application program;
transmitting said first redirection instruction to a request handling program; and
instructing said request handling program with said first redirection instruction to transmit said client request to a second application program to serve said client request.

2. The method of claim 1, further comprising the steps of:
selecting said second application program for serving said client request based on available application programs; and
adding to a first redirection instruction address information of said second application program for serving said client request.

3. The method of claim 1, wherein with respect to said receiving step, said client request is received at said request handling program before being forwarded by said request handling program to said first application program; and
wherein said first redirection instruction includes information specifying that said request handling program is selected for redirecting said client request to said second application program.

4. The method of claim 1, wherein said client request includes an internal resource locator previously transmitted from said first application program to said client and specifying a requested resource, said internal resource locator being valid in a communication between said first application program and said client.

5. The method of claim 4, wherein said generating step comprises the steps of:
obtaining an external resource locator based on said internal resource locator, said external resource locator allowing said second application program to access a resource; and
including said external resource locator into said first redirection instruction.

6. The method of claim 5, wherein said generating step further comprises a look-up operation in a resource locator table associating internal resource locators and external resource locators at least used by said second application program, said internal resource locator constituting an address for indexing into said resource locator table to identify said external resource locator.

7. The method of claim 6, wherein said redirection instruction instructs said request handling program to modify said client request based on information included in said redirection instruction.

8. The method of claim 7, wherein said modification of said client request includes at least one of:
replacing said internal resource locator by said external resource locator; and
including address information of said second application program into the client request to be forwarded to the secondary application program.

9. The method of claim 1, wherein said first redirection instruction is generated based on a first part of said client request, and a second part of said client request is served by said first application program.

10. The method of claim 9, further comprising the steps of:
determining a third application program for serving a third part of said client request;
generating a second redirection instruction based on said third part of said client request; and
transmitting said second redirection instruction to said request handling program, instructing said request handling program to transmit a modified client request to said third application module.

11. The method of claim 1, wherein said first and second application programs are executed on a single server.

12. The method of claim 1, wherein said first application program is executed on a first server, said second application program is executed on a second server remote from said first server; and
wherein said request handling program comprises a data processing device further including functions of at least one of a load balancer and firewall.

13. A method in a data processing system of redirecting client requests at a server, comprising the steps of:
receiving at a request handling program, a client request from a client;
forwarding said client request to a first application program;
receiving at said request handling program, a first redirection instruction from said first application program; and
forwarding said client request to a second application program.

14. The method of claim 13, further comprising the step of:
forwarding a response to said client request from said second application program to said client.

15. The method of claim 13, wherein said first redirection instruction includes address information of said second application program and information specifying that said request handling program is selected for transmitting said first redirection instruction to said second application program.

16. The method of claim 13, wherein said client request includes an internal resource locator previously transmitted from said first application program to said client and specifying a requested resource, said internal resource locator being valid in a communication between said first application program and said client.

17. The method of claim 16, wherein said first redirection instruction includes an external resource locator associated with said internal resource locator, said external resource locator allowing said second application program to access a resource.

18. The method of claim 17, wherein said request handling program intermediately saves and modifies said client request based on information included in said redirection instruction.

19. The method of claim 18, wherein said modification of said client request includes at least one of:
replacing said internal resource locator by said external resource locator; and
including address information of said second application program into said client request.

20. The method of claim 13, wherein said first redirection instruction is associated with a first part of said client request; and
wherein a second part of said client request is served by said first application program by transmitting a response to said client through said request handling program.

21. The method of claim 20, further comprising the steps of:
receiving a third redirection request based on a third part of said client request; and
transmitting said third redirection request to a third application program for serving said third redirection request.

22. The method of claim 13, further comprising the step of:
determining said second application program for serving said client request, when said first application program and said second application program do not form part of a same application.

23. The method of claim 13, wherein said request handling program communicates with a server executing said first and second application programs.

24. The method of claim 13, wherein said request handling program communicates with a first server executing said first application program and with a second server executing said second application program.

25. The method of claim 13, wherein said request handling program is one of a plurality of request handling programs, and each of said request handling programs further executes functions of at least one of a load balancer and firewall.

26. The method of claim 13, wherein said client request includes at least one of:
a plurality of internal resource locators; and
a plurality of external resource locators.

27. The method of claim 17, wherein said first and second application programs are comprised by Java servlets; and a second resource locator includes a URL.

28. A data processing system in a client and server system, for redirecting client requests at a server, the system comprising:
a server computer comprising:
at least one memory including a plurality of server programs of which a first application program receives a client request from a client; generates a first redirection instruction based on said client request; transmits said first redirection instruction to a request handling program; and instructs said request handling program with said first redirection instruction to transmit said client request to a second application program to serve said client request; and
at least one processor that runs said server programs.

29. A computer readable medium containing instructions that cause a data processing system in a client and server system, to perform a method of redirecting client requests at a server, the method comprising the steps of:
receiving a client request from a client at a first application program;
generating a first redirection instruction based on said client request at said first application program;
transmitting said first redirection instruction to a request handling program; and
instructing said request handling program with said first redirection instruction to transmit said client request to a second application program to serve said client request.

30. The computer readable medium of claim 29, further comprising the steps of:
selecting said second application program for serving said client request based on available application programs; and
adding to a first redirection instruction address information of said second application program for serving said client request.

31. The computer readable medium of claim 29, wherein with respect to said receiving step, said client request is received at said request handling program before being forwarded by said request handling program to said first application program; and
wherein said first redirection instruction includes information specifying that said request handling program is selected for redirecting said client request to said second application program.

32. The computer readable medium of claim 29, wherein said client request includes an internal resource locator previously transmitted from said first application program to said client and specifying a requested resource, said internal resource locator being valid in a communication between said first application program and the client.

33. The computer readable medium of claim 32, wherein said generating step comprises the steps of:
obtaining an external resource locator based on said internal resource locator, said external resource locator allowing said second application program to access a resource; and
including said external resource locator into said first redirection instruction.

34. The computer readable medium of claim 33, wherein said generating step further comprises a look-up operation in a resource locator table associating internal resource locators and external resource locators at least used by the second application program, said internal resource locator constituting an address for indexing into said resource locator table to identify said external resource locator.

35. The computer readable medium of claim 34, wherein said redirection instruction instructs said request handling program to modify said client request based on information included in said redirection instruction.

36. The computer readable medium of claim 35, wherein said modification of said client request includes at least one of:
replacing said internal resource locator by said external resource locator; and
including address information of said second application program into the client request to be forwarded to the secondary application program.

37. The computer readable medium of claim 29, wherein said first redirection instruction is generated based on a first part of said client request, and a second part of said client request is served by said first application program.

38. The computer readable medium of claim 37, further comprising the steps of:
determining a third application program for serving a third part of said client request;
generating a second redirection instruction based on said third part of said client request; and
transmitting said second redirection instruction to said request handling program, instructing said request handling program to transmit a modified client request to said third application module.

39. The computer readable medium of claim 29, wherein said first and second application programs are executed on a single server.

40. The computer readable medium of claim 29, wherein said first application program is executed on a first server, said second application program is executed on a second server remote from said first server; and
wherein said request handling program comprises a data processing device further including functions of at least one of a load balancer and firewall.

41. A data processing system in a client and server system, for redirecting client requests from the client at the server, the system comprising:
a server computer comprising:
at least one memory including a plurality of server programs of which a first application program receives a client request from a client; generates a first redirection instruction based on said client request; transmits said first redirection instruction to a request handling program; instructs said request handling program with said first redirection instruction to transmit said client request to a second application program to serve said client request; and transmits a response from said second application program to the client; and
at least one processor that runs said server programs;
a client computer comprising:
a memory including a client program that provides a client request to the server, and that receives said response sent by said second application program at the server; and
a processor that runs said client program; and
a network between said server computer and said client computer.

42. An apparatus which provides, in a client and server system, redirection of client requests at a server, said apparatus comprising:
means for receiving a client request from a client at a first application program;
means for generating a first redirection instruction based on said client request at said first application program;
means for transmitting said first redirection instruction to a request handling program; and
means for instructing said request handling program with said first redirection instruction to transmit said client request to a second application program to serve said client request.

43. A method in a data processing system of redirecting client requests at a server, comprising the steps of:
receiving at a request handling program, a client request from a client;
forwarding said client request to a first application program;
generating a first redirection instruction based on said client request at said first application program;
transmitting said first redirection instruction to said request handling program;
instructing said request handling program with said first redirection instruction, to transmit said client request to a second application program to serve said client request;
transmitting a response from said second application program to said request handling program; and
transmitting said response to said client.
